(19) United States
(12) Patent Application Publication
(10) Pub. No.: US 2008/0084939 A1
(43) Pub. Date: Apr. 10, 2008

(54) Sample Buffer Size Reduction for Synchronized DMT-VDSL With Shared FFT Compute Units

(75) Inventor: Michael Eugene Locke, Santa Clara, CA (US)

Correspondence Address: TEXAS INSTRUMENTS INCORPORATED, P O BOX 655474, M/S 3999, DALLAS, TX, 75265, US

(73) Assignee: TEXAS INSTRUMENTS

(21) Appl. No.: 11/539,552

(22) Filed: Oct. 6, 2006

(51) Int. Cl. H04L 27/28

(52) U.S. Cl. 375/260; 375/E07.021

(57) ABSTRACT

A communication system and method for a multiple channel communication system includes separating a symbol into two or more channels; performing a transform operation on each of the channels; and timing the output of each of the transform operations to enable one or more sample buffers to receive the output of each of the channels substantially when the one or more sample buffers require the output of each of the transform operations. Another method for receiving a symbol for use in a digital subscriber line communication system includes receiving the symbol in two or more components at one or more receive buffers; and timing the output of each of the receive buffers to enable one or more receive buffers to transmit the output to each of two or more transform components substantially when the one or more receive buffers hold a multiple of a full frequency domain symbol.

### TECHNICAL FIELD OF THE DISCLOSURE

Embodiments herein relate generally to the field of DMT-VDSL transceivers, and, more particularly, to a method of reducing sample buffer requirements.

### BACKGROUND OF THE DISCLOSURE

Emerging high bandwidth applications such as Video-On-Demand are driving a need for higher speed broadband connections to homes and businesses. Discrete Multi-tone Very High Bit Digital Subscriber Line (DMT-VDSL) is a technology that can provide high data rates over standard phone lines when the distance from a central office to a customer site is 5000 feet or less. The available bandwidth is affected by several factors but generally decreases with increasing length of the phone line. Therefore, the service provider can offer higher data rates to customers located on shorter phone lines.

DMT-VDSL requires the calculation of large fast Fourier transforms (FFT) and inverse fast Fourier transforms (IFFT) for the high data rate connections. The size of the FFT and IFFT can be altered when the data rate is lower due to a longer phone line or lower customer service level. More particularly, a smaller size FFT and IFFT can be calculated. If N is the transform size, the memory requirement of an FFT or IFFT transform is proportional to N and the computational requirement is proportional to N*log(N). Therefore, the hardware that calculates an N-sized transform can calculate two N/2 sized transforms or four N/4 sized transforms using the same resources. Because a central office DMT-VDSL device generally services more than one phone line, the central office can take advantage of the smaller transforms and provide two or four channels of lower data rate service using the same FFT hardware that is needed for one high data rate connection.

The N samples output from the IFFT transform in a DMT-VDSL device are the time domain representation of a symbol of data. A symbol is generated and transmitted at a periodic rate of about 4 KHz. After optionally adding a cyclic extension to the time domain symbol, the DMT-VDSL device transmits the samples to an analog front end (AFE) at a sample rate determined by the AFE. A rate matching buffer is used to store the IFFT output and provide a constant sample stream to the AFE. For central office devices, synchronizing the symbols on all channels is beneficial in that the effect of near end cross talk on the signal reception is reduced. Synchronizing the symbols and sharing the FFT hardware across multiple channels increases the amount of storage required for the rate matching buffers. The amount of additional storage required depends on the number of computed IFFTs. The total buffer requirement for two N/2 rate channels can exceed the requirement for one N rate. Likewise, the total buffer requirement for four N/2 rate channels can exceed the requirement for two N/2 rate channels. To minimize costs for multi-channel implementations, a solution is needed that does not increase buffer requirements as the FFT resources are shared between multiple channels.

What is needed is an apparatus and method that reduces the sample buffer requirement for multi-channel synchronized DMT-VDSL devices utilizing shared FFT compute units.

### SUMMARY

In one aspect, a method for preparing a symbol for use in a multiple channel communication system includes but is not limited to separating the symbol into two or more channels; performing a transform operation on each of the two or more channels; and timing the output of each of the transform operations to enable one or more sample buffers to receive the output of each of the two or more channels substantially when the one or more sample buffers require the output of each of the transform operations.

In another aspect, a method for receiving a symbol for use in a digital subscriber line (DSL) communication system is provided. The method includes receiving the symbol in two or more components at one or more receive buffers; and timing the output of each of the receive buffers to enable one or more receive buffers to transmit the output to each of two or more transform components substantially when the one or more receive buffers hold a multiple of a full frequency domain symbol. Other methods are described in the claims, drawings, and text forming a part of the application.

In another aspect, a computer program product includes but is not limited to a signal bearing medium bearing at least one of one or more instructions for preparing a symbol for use in a multiple channel communication including one or more instructions for separating the symbol into two or more channels; one or more instructions for performing a transform operation on each of the two or more channels; one or more instructions for timing the output of each of the transform operations to enable one or more sample buffers to receive the output of each of the two or more channels substantially when the one or more sample buffers require the output of each of the transform operations; and one or more instructions for providing the separated symbol to at least two components, including a first compute component for at least a first channel, and a second compute component for at least a second channel.

In another aspect, a computer program product includes but is not limited to a signal bearing medium bearing at least one of one or more instructions for preparing a symbol for use in a multiple channel communication including one or more instructions for receiving the symbol in two or more components at one or more receive buffers; and one or more instructions for timing the output of each of the receive buffers to enable one or more receive buffers to transmit the output to each of two or more transform components substantially when the one or more receive buffers hold a multiple of a full frequency domain symbol. In addition to the foregoing, other computer program product aspects are described in the claims, drawings, and text forming a part of the application.

In another aspect, a communication system is provided including an analog front end (AFE) configured to receive a symbol for digital subscriber line communication; one or more sample buffers coupled to the AFE, the one or more sample buffers configured to transmit and/or receive the symbol in two or more channels; and two or more compute buffers coupled to the one or more sample buffers, the two or more compute buffers configured to time one or more transform operations to enable the one or more sample buffers to receive the output of each of the two or more channels substantially when the one or more sample buffers require output of each of the one or more transform operations and transfer the output of each of the two or more channels to the one or more sample buffers substantially simultaneously.

In another aspect, a communication system is provided including one or more receive buffers configured to receive a symbol in two or more components; and timing means coupled to the one or more receive buffers, the timing means configured to enable the one or more receive buffers to transmit the output to each of two or more transform components substantially when the one or more receive buffers hold a multiple of a full frequency domain symbol. In one or more various aspects, related systems include but are not limited to circuitry and/or programming for affecting the herein-referenced method aspects; the circuitry and/or programming can be virtually any combination of hardware, software, and/or firmware configured to affect the herein-referenced method aspects depending upon the design choices of the system designer. In addition to the foregoing, other system aspects are described in the claims, drawings, and text forming a part of the application.

In addition to the foregoing, various other method, system, computer program product, and/or transferable device aspects are set forth and described in the text (e.g., claims and/or detailed description) and/or drawings of the application.

The foregoing is a summary and thus contains, by necessity, simplifications generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

For a more complete understanding of the disclosure, and the advantages thereof, reference is now made to the following brief descriptions taken in conjunction with the accompanying drawings.

FIG. 1, labeled “prior art” is a block diagram showing the transmit portion of a single channel DMT-VDSL device.

FIG. 2 is a block diagram showing the transmit portion of a two channel DMT-VDSL device in accordance with an embodiment.

FIG. 3, labeled “prior art”, is a scheduling diagram illustrating a prior art method for scheduling transmit operations in a multi-channel DMT-VDSL device.

FIG. 4 is a scheduling diagram illustrating a method for scheduling transmit operations to minimize buffer memory in accordance with an embodiment.

FIG. 5 is a scheduling diagram illustrating an alternative method for scheduling operations to minimize buffer memory in accordance with an embodiment.

FIGS. 6 and 7 illustrate a flow diagram illustrating a method in accordance with an embodiment.

FIG. 8 labeled “prior art”, is a scheduling diagram illustrating a prior art method for scheduling receive operations in a multi-channel DMT-VDSL device.

FIG. 9 is a block diagram showing the receive portion of a two channel DMT-VDSL device described by an embodiment.

FIG. 10 labeled “prior art” is a block diagram showing the receive portion of a single channel DMT-VDSL device.

FIG. 11 is a scheduling diagram illustrating a method for scheduling receive operations to minimize buffer memory in accordance with an embodiment.

FIG. 12 is a flow diagram illustrating a method for processing the receive channels in accordance with an embodiment.

### DETAILED DESCRIPTION

An apparatus and method is disclosed that reduces the sample buffer requirement for multi-channel synchronized DMT-VDSL devices utilizing shared FFT compute units. The apparatus and method takes advantage of the memory in the FFT compute unit to accomplish symbol synchronization across the channels that share the FFT compute unit. Because symbol synchronization occurs in the FFT compute unit, no additional memory is required in the sample buffer for that purpose. The result is that an FFT compute unit and sample buffer sized for IFFT transforms of size N can also support M channels of N/M size with no additional sample buffer memory.

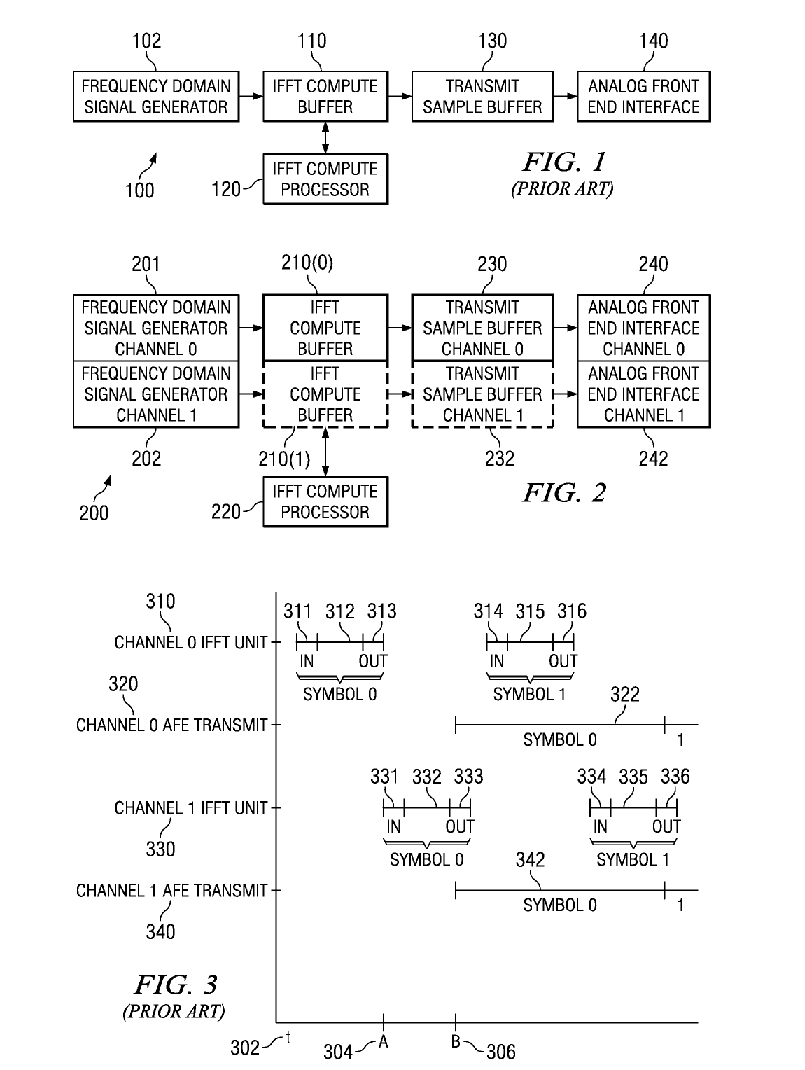

FIG. 1, labeled “prior art”, depicts a block diagram of the transmit subsystem 100 of a single channel DMT-VDSL device. Transmit subsystem 100 includes frequency domain signal generator 102, IFFT compute buffer 110, IFFT compute processor 120, transmit sample buffer 130, and analog front end (AFE) interface 140. Signal generator 102 produces a set of complex values representing the constellations to be encoded in the DMT signal. The set of complex values are copied to the IFFT compute buffer 110. Next, an IFFT transform is calculated using the compute processor 120 and compute buffer 110. Compute buffer 10 is sized to hold the IFFT input transfer and all local storage required for an IFFT transform of the maximum size, N. When IFFT calculations are complete, the resulting time domain signal is transferred to the transmit sample buffer 130. The AFE interface 140 continuously reads samples from the sample buffer 130 at the sample rate required for the external AFE. Sample buffer 130 performs rate matching between the block transfer from the IFFT compute buffer 110 and the continuous sampling of the AFE interface 140. Sample buffer 130 is also sized to support a time domain signal of the maximum size, N.

FIG. 2 depicts a block diagram of the transmit subsystem 200 of a two channel DMT-VDSL device. Transmit subsystem 200 can be configured with the same components as the single channel subsystem but also includes an additional frequency domain signal generator 202 and AFE interface 242. More specifically, transmit subsystem 200 includes frequency domain signal generator for channel 0 201 and frequency domain signal generator channel 1 202, IFFT compute buffers 210(0) and 210(1), IFFT compute processor 220, transmit sample buffer for channel 0 230, transmit sample buffer for channel 1 232, analog front end (AFE) interface 240 for channel 0 and analog front end interface for channel 1 242. The two channel device operates with a sample rate and IFFT size of N/2. Therefore, buffers shown in FIG. 1, IFFT compute buffer 110 and transmit sample buffer 130 can be allocated to each of the two channels as shown as IFFT compute buffer 210(0), and IFFT compute buffer 210(1) and transmit sample buffer channel 0 230 and transmit sample buffer channel 1 232. Specifically, according to prior art allocations, transmit sample buffer 230 can be ¾ the size of the transmit sample buffer 130 (assuming that ½ size FFT plus transfer times require ½ of a symbol time). Transmit sample buffer 232 must be ½ the size of transmit sample buffer 130 to synchronize the transmitted symbols. The extra size of transmit sample buffer 230 permits a delay of the start of the symbol. The extra time and corresponding buffer size results in the combination of transmit sample buffer 230 and transmit sample buffer 232 being 1.25 times larger than the size of transmit sample buffer 130. To maintain synchronous operation, the two AFE interfaces 240 and 242 must transmit the channel 0 and 1 symbols aligned. The first sample for each symbol from channel 0 must be transmitted with the first sample for channel 1 and so on for all samples. Although FIG. 2 depicts a dual channel transmit subsystem the same method applies to an M-channel subsystem. In that case, the transmit sample buffer memories are logically divided by M and the IFFT transform size is N/M. The IFFT compute processor 220 is capable of performing M IFFT transforms of size N/M in the same time as one size N transform.

3 shows a prior art scheduling graph for the two channel transmitter depicted in FIG. 2. The scheduling graph illustrates an x-axis illustrating time 302, and two points in time, A 304 and B 306. The y-axis illustrates channel 0 IFFT unit transfers 310, channel 0 AFE transmit 320, channel 1 IFFT unit transfers 330 and channel 1 AFE transmit 340.

For scheduling purposes, the IFFT unit processing time for Channel 0 IFFT Unit 310 is divided into an input transfer 311, transform calculation 312, and output transfer 313 for symbol 0; and input transfer 314, transform calculation 315, and output transfer 316 for symbol 1.

Likewise, for scheduling purposes the IFFT unit processing time for Channel 1 IFFT Unit 330 is divided into an input transfer 331, transform calculation 332, and output transfer 333 for symbol 0; and input transfer 334, transform calculation 335, and output transfer 336 for symbol 1.

FIG. 3 further shows the relative timing of these activities for each of the two channels over a time duration in which two symbols are processed, symbol 322 and symbol 342. The prior art method executes the IFFT input transfer, transform calculation, and output transfer for channel 0 followed by the same sequence for channel 1. The first symbol 0 is available to be transmitted by an AFE interface after some portion of the channel 1 IFFT output transfer is complete. Channel 0 and 1 must be synchronized. Thus, the AFE transmission for channel 0 cannot start until channel 1 data is also available at time B. The difference between the time that channel 0 transfers a symbol of data to a sample buffer (shown as time A 304) and the sample buffer begins transferring the same symbol to the AFE (shown as time B 306) determines how much additional memory will be needed to support two channels in a sample buffer. The same analysis can be applied to four or more channels, as will be appreciated by one of skill in the art. In all cases, the amount of additional memory depends heavily on the speed of the IFFT compute processor 220. Note that if an AFE transmits ½ of a symbol during the time period between A 304 and B 306, then the sample buffer for channel 0 must be increased by ½.

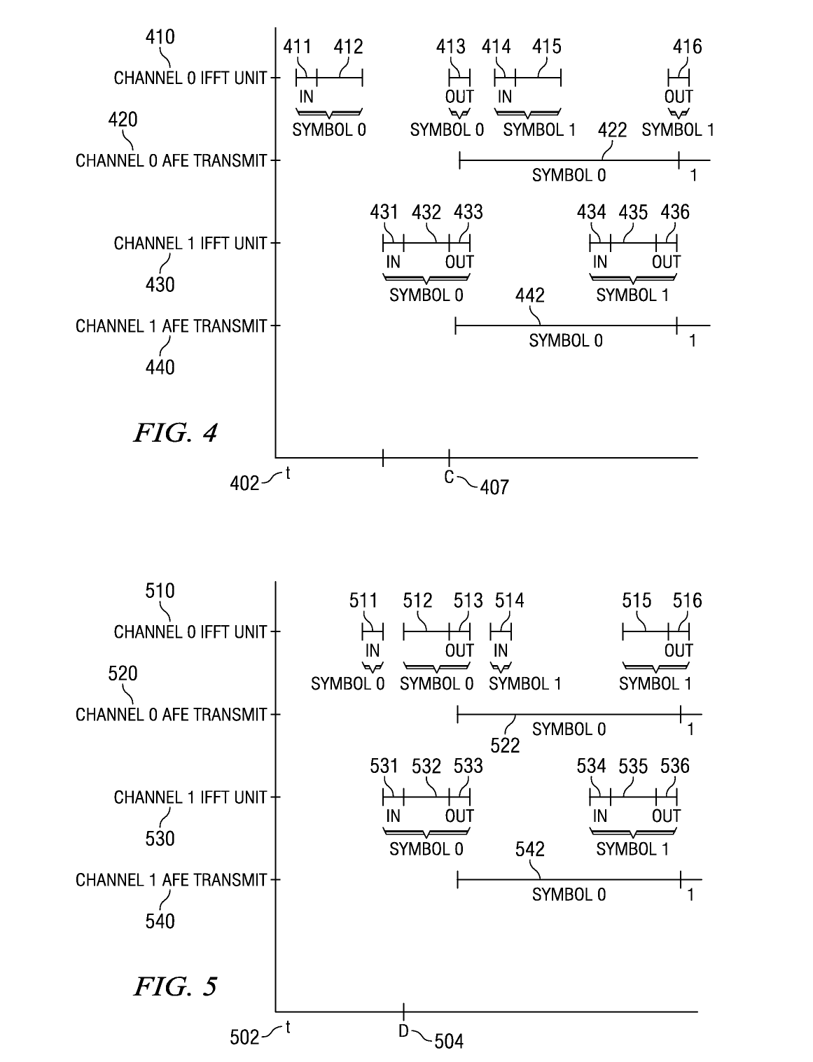

FIG. 4 depicts a graph of a scheduling method for the two channel transmitter in FIG. 2.

Although the diagram depicts two channels the method can be extended to M channels of IFFT size N/M without adding additional memory to sample buffer 230 and 232, as will be appreciated by one of ordinary skill in the art with the benefit of the disclosure. As shown in FIG. 4, a scheduling graph illustrates x-axis illustrating time 402. The y-axis illustrates channel 0 IFFT unit transfers 410, channel 0 AFE transmit 420, channel 1 IFFT unit transfers 430 and channel 1 AFE transmit 440.

For scheduling purposes the IFFT unit processing time for Channel 0 IFFT Unit 410 is divided into an input transfer 411, transform calculation 412, and output transfer 413 for symbol 0; and input transfer 414, transform calculation 415, and output transfer 416 for symbol 1.

Likewise, for scheduling purposes the IFFT unit processing time for Channel 1 IFFT Unit 430 is divided into an input transfer 431, transform calculation 432, and output transfer 433 for symbol 0; and input transfer 434, transform calculation 435, and output transfer 436 for symbol 1.

FIG. 4 further shows the relative timing of these activities for each of the two channels over a time duration in which two symbols are processed, symbol 422 and symbol 442.

According to an embodiment, the IFFT output transfer to the sample buffer 413 is delayed as compared to prior art IFFT output transfer 313 shown in FIG. 3. The delay can be until the calculations performed by the Channel 1 IFFT unit for channel 1, shown as 432, are complete shown as time C 407. The delay made possible because the IFFT compute buffer is logically divided into two components, IFFT compute buffer 210(0) for channel 0 and 210(1) for channel 1. When both the channel 0 and 1 transforms have been calculated, the output data for each channel is then transferred to sample buffers 230 and 232, respectively, at roughly the same time. Because sample buffers 230 and 232 are not filled until after they have been emptied by AFE interface 240 and 242, no additional memory is needed as compared to the single channel, maximum sample rate transmitter depicted in FIG. 1. Because both channels fill and empty sample buffer 230 and 232 with no overlap, no additional memory is needed as compared to the single channel, maximum sample rate transmitter depicted in FIG. 1.

FIG. 5 depicts an alternative scheduling method for the two-channel transmitter in FIG. 2 which also removes the requirement for additional space in a sample buffer, such as sample buffer 130 illustrated in FIG. 1. The scheduling graph illustrated in FIG. 5 requires the IFFT compute processor 120 to be capable of computing the IFFT transform for both channels simultaneously. More specifically, FIG. 5 depicts a graph of a scheduling method for the two channel transmitter in FIG. 2 which removes the requirement for additional memory in sample buffers 230 and 232.

Although the diagram depicts two channels the method can be extended to M channels of IFFT size N/M without adding additional memory to sample buffer 230 and 232, as will be appreciated by one of ordinary skill in the art with the benefit of the disclosure. As shown in FIG. 5, a scheduling graph illustrates x-axis illustrating time 502. The y-axis illustrates channel 0 IFFT unit transfers 510, channel 0 AFE transmit 520, channel 1 IFFT unit transfers 530 and channel 1 AFE transmit 540.

For scheduling purposes the IFFT unit processing time for Channel 0 IFFT Unit 510 is divided into an input transfer 511, transform calculation 512, and output transfer 513 for symbol 0; and input transfer 514, transform calculation 515, and output transfer 516 for symbol 1.

Likewise, for scheduling purposes the IFFT unit processing time for Channel 1 IFFT Unit 530 is divided into an input transfer 531, transform calculation 532, and output transfer 533 for symbol 0; and input transfer 534, transform calculation 535, and output transfer 536 for symbol 1.

FIG. 5 further shows the relative timing of these activities for each of the two channels over a time duration in which two symbols are processed, symbol 522 and symbol 542. According to an embodiment, the IFFT input transfer to the sample buffer 511 is separated from the transform calculation 512 and the output transfer 513 as compared to the input transfer 311 or input transfer 411. Further, as shown, in an embodiment, input transfer 531 follows input transfer to sample buffer 511 substantially immediately, and transform calculation 512 and Channel 1 IFFT unit 532 calculation is performed substantially simultaneously.

As shown, the transform calculation 512 is delayed as compared to prior art transform calculation 312 shown in FIG. 3, and transform calculation 412 shown in FIG. 4. The delay for transform calculation 512 can be until the input transfer 531 is complete, performed by the Channel 1 IFFT unit for channel 1, shown as 532, shown as time D 504. The delay is possible because the IFFT compute buffer is logically divided into two components, IFFT compute buffer 210(0) for channel 0 and 210(1) for channel 1. When both the channel 0 and 1 transforms have been calculated, the output data for each channel is then transferred to sample buffers 230 and 232, respectively, at roughly the same time. Because both channels fill and empty sample buffer 230 and 232 at the appropriate times, no additional memory is needed as compared to the single channel, maximum sample rate transmitter depicted in FIG. 1.

FIGS. 3, 4, and 5 depict relative scheduling, no other timing details should be assumed. A person skilled in the art could produce other scheduling variations that would have the same memory reduction effect as those presented in FIGS. 4 and 5. The disclosed scheduling methods reduce the memory requirements for the sample buffer 130 by aligning the symbols from multiple channels in the IFFT compute buffer 110 instead of the sample buffer 130. Since the IFFT compute buffer 110 does not need to increase in size, embodiments herein reduce overall memory requirements for DMT-VDSL multi-channel synchronous devices.

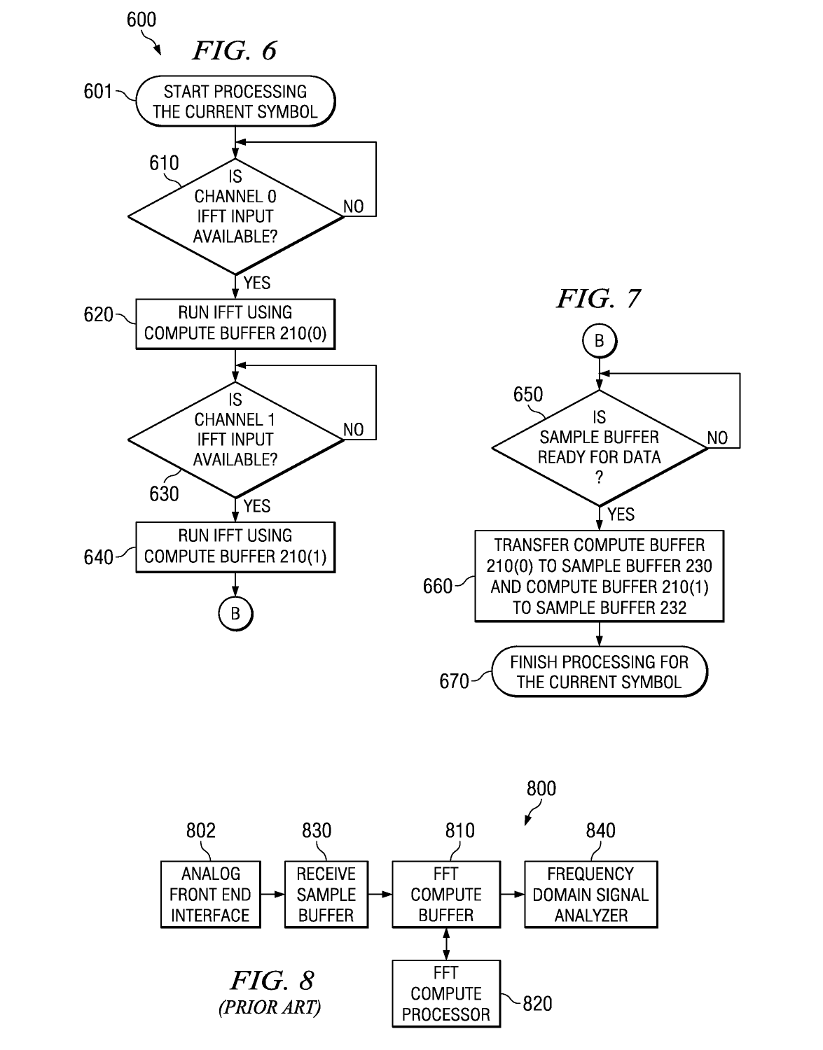

Referring now to FIGS. 6 and 7, a flow diagram illustrates a method in accordance with one or more embodiments. The flow diagram is entered at the start of each new transmitter symbol period 601. In block 610, the transmitter waits for the frequency domain signal generator 202 to prepare a symbol of data for the channel 0 IFFT. When the data is available, the data is transferred into the IFFT compute buffer 210(0) and the compute processor 220 performs the IFFT transform calculations as shown in block 620. The resulting time domain signal is stored in compute buffer 210(0) for future use. The transmitter then waits, as shown in block 630 for the frequency domain signal generator 201 to prepare a symbol of data for channel 1. When the data is available, the transmitter transfers the data to compute buffer 210(1) and computes the IFFT transform as shown in block 640. After computing the IFFT transform, the transmitter waits, as shown in block 650, for the sample buffer 230 to be ready to accept the data. The sample buffer 230 can be sized to require the transmitter to wait to avoid the sample buffer 230 receiving data before the sample buffer 230 has transmitted a prior symbol. Thus, sample buffer 230 can be sized to the size of a transfer symbol rather than a larger size to accommodate data larger than a symbol.

In block 660, when the sample buffer 230 is ready, the data from compute buffer 210(0) is transferred to sample buffer 230, and the data from compute buffer 210(1) is transferred to sample buffer 232. Block 670 illustrates that the method is finished as to a current symbol. As a result of the scheduling, both sample buffers 230 and 232 receive the data substantially at a time not requiring the sample buffers to store more than one symbol of data, and therefore minimizes the size of the buffers.

FIG. 8, labeled “prior art”, depicts a block diagram of the receive subsystem 800 of a single channel DMT-VDSL device. Receive subsystem 800 includes analog front end interface 802, FFT compute buffer 810, FFT compute processor 820, receive sample buffer 830, and frequency domain signal analyzer 840. Analog front end device 802 provides samples to the receive sample buffer 830 at a constant rate. After a symbol of data is stored in the receive sample buffer 830 the symbol is copied to the FFT compute buffer 810. Next, an FFT transform is calculated using the compute processor 820 and compute buffer 810. Compute buffer 810 is sized to hold the FFT input transfer and all local storage required for an FFT transform of the maximum size, N. When FFT calculations are complete, the resulting frequency domain signal is transferred to the frequency domain signal analyzer 840. Sample buffer 830 performs rate matching between the continuous sampling of the analog front end interface 802 and the block transfer to the FFT compute buffer 810. Sample buffer 830 is sized to support a time domain signal of the maximum size, N.

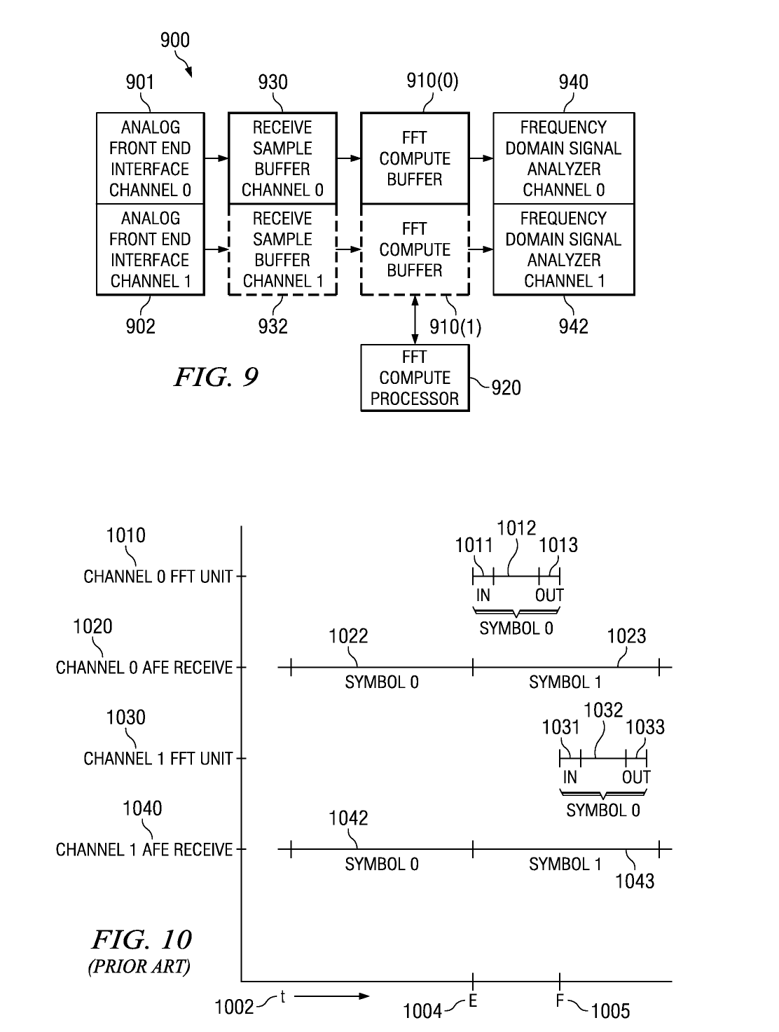

FIG. 9 depicts a block diagram of the receive subsystem 900 of a two channel DMT-VDSL device constructed according to an embodiment. Receive subsystem 900 can be configured with the same components as the single channel subsystem but also includes an additional analog front end interface 902 and frequency domain signal analyzer 942. More specifically, receive subsystem 900 includes analog front end interface for channel 0 901 and analog front end interface for channel 1 902, FFT compute buffers 910(0) and 910(1), FFT compute processor 920, receive sample buffer for channel 0 930, receive sample buffer for channel 1 932, frequency domain signal analyzer 940 for channel 0 and frequency domain signal analyzer for channel 1 942. The two channel device operates with a sample rate and FFT size of N/2. Therefore, buffers shown in FIG. 8, FFT compute buffer 810 and receive sample buffer 830 can be logically divided in half and allocated to each of the two channels as shown as FFT compute buffer 910(0), and FFT compute buffer 910(1) and receive sample buffer channel 0 930 and receive sample buffer channel 1 932. To maintain synchronous operation, the two AFE interfaces 901 and 902 must receive the channel 0 and 1 symbols aligned. The first sample for each symbol from channel 0 must be received with the first sample for channel 1 and so on for all samples. Although FIG. 9 depicts a dual channel receive subsystem the same method applies to an M-channel subsystem. In that case, the memories are logically divided by M and the FFT transform size is N/M. The FFT compute processor 920 is capable of performing M FFT transforms of size N/M in the same time as one size N transform.

FIG. 10 shows a prior art scheduling graph for the two channel receiver depicted in FIG. 9. The scheduling graph illustrates an x-axis illustrating time 1002, and two points in time, E 1004 and F 1006. The y-axis illustrates channel 0 FFT unit transfers 1010, channel 0 AFE receive 1020, channel 1 FFT unit transfers 1030 and channel 1 AFE receive 1040.

For scheduling purposes, the FFT unit processing time for Channel 0 FFT Unit 1010 is divided into an input transfer 1011, transform calculation 1012, and output transfer 1013 for symbol 0.

Likewise, for scheduling purposes the FFT unit processing time for Channel 1 FFT Unit 1030 is divided into an input transfer 1031, transform calculation 1032, and output transfer 1033 for symbol 0.

FIG. 10 further shows the relative timing of these activities for each of the two channels over a time duration in which two symbols are received from the AFE, symbol 1022 and symbol 1023 for channel 0, and symbol 1042 and symbol 1043 for channel 1. After receiving symbol 1022 and symbol 1042 the prior art method executes the FFT input transfer, transform calculation, and output transfer for channel 0 followed by the same sequence for channel 1. The first symbol 1022 for channel 0 is available to be transferred to the FFT unit after all or most of the symbol has been received from the AFE interface. Since channel 0 and 1 are synchronized the symbol 1042 for channel 1 is available to be transferred to the FFT unit at the same time. However, the FFT unit input transfer 1031 for channel 1 cannot occur until the FFT unit has completed all processing for channel 0 (shown as time F 1006). At time E 1004 symbol 0 for both channels has been completely received from the AFE interface and the AFE interface begins providing samples for symbol 1. The difference between the time that symbol 0 is completely received (shown as time E 1004) and channel 1 begins to transfer to the FFT unit (shown as time F 1006) determines the amount of additional memory that is required to hold symbol 1043 data in receive sample buffer 932. The same analysis can be applied to four or more channels, as will be appreciated by one of skill in the art. In all cases, the amount of additional memory depends heavily on the speed of the FFT compute processor 920.

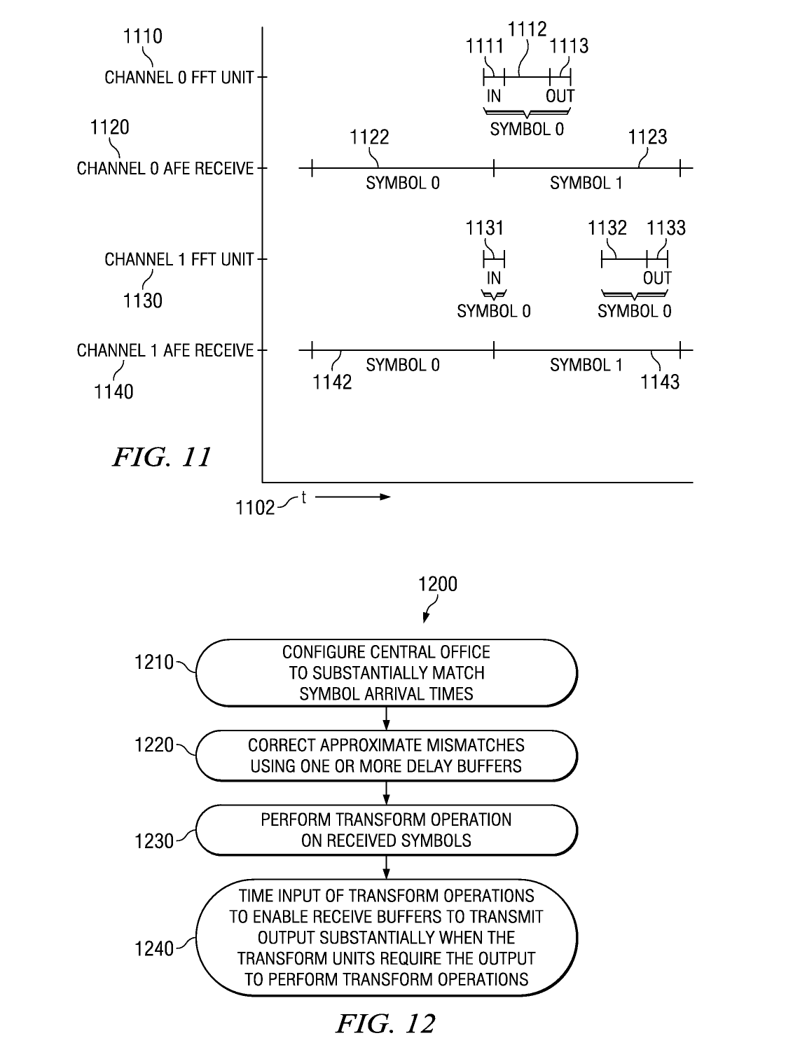

FIG. 11 depicts a graph of a scheduling method for the two channel receiver in FIG. 9 which removes the requirement for additional memory in sample buffers 930 and 932.

Although the diagram depicts two channels the method can be extended to M channels of FFT size N/M without adding additional memory to sample buffer 930 and 932, as will be appreciated by one of ordinary skill in the art with the benefit of the disclosure. As shown in FIG. 11, a scheduling graph illustrates x-axis illustrating time 1102. The y-axis illustrates channel 0 FFT unit transfers 1110, channel 0 AFE receive 1120, channel 1 FFT unit transfers 1130 and channel 1 AFE receive 1140.

For scheduling purposes, the FFT unit processing time for Channel 0 FFT Unit 1110 is divided into an input transfer 1111 and transform calculation 1112 and output transfer 1113 for symbol 0.

Likewise, for scheduling purposes the FFT unit processing time for Channel 1 FFT Unit 1130 is divided into an input transfer 1131, transform calculation 1132, and output transfer 1133 for symbol 0.

FIG. 11 further shows the relative timing of these activities for each of the two channels over a time duration in which two symbols are received, symbol 1122 and symbol 1123 as shown in Channel 0 AFE 1120 and symbol 1142 and symbol 1143 as shown in Channel 1 AFE 1140.

According to an embodiment, the FFT input transfer 1131 is separated from the transform calculation 1132 and the input transfer 1133. Further, as shown, in an embodiment, input transfer 1133 for channel 1 occurs at the same time as input transfer 1111 for channel 0. Since symbol 1122 and symbol 1142 are removed from the receive sample buffers 930 and 932 at the same time, no additional memory is needed in receive sample buffer 932 to store symbol 1143. As shown the FFT unit completes transform calculation 1112 and output transfer 1113 for channel 0 followed by transform calculation 1132 and output transfer 1133 for channel 1. As one of skill in the art will appreciate, other scheduling orders for 1112, 1113, 1132, and 1133 are possible without altering the principles of embodiments herein. As long as both FFT input transfers 1111 and 1131 occur at essentially the same time no additional space will be required in receive sample buffers 930 and 932 to support two N/2 sized channels.

Referring now to FIGS. 11 and 12, an embodiment is directed to an implementation for a receive path. More particularly, a flow diagram illustrates a method for receiving once the transmit symbols have been aligned. Block 1210 provides for configuring a central office to substantially match symbol arrival times. More particularly, a central office can be configured to force the receive symbol arrive times to match. Specifically, the VDSL1 and VDSL2 (ITU-T G.993.1) recommendations specify a mechanism to achieve the matching of symbol arrive times. The matching arrival times enable a minimization of near end cross talk and can approximate matching arrival times. Block 1220 provides for correcting approximate mismatches using one or more delay buffers. In an embodiment, small mismatches in the arrival times can be corrected via small delay buffers in the receive path. Once the receive symbols have been forced to exactly equal arrival times, the receive path can efficiently utilize an FFT compute buffer that is sized for one large FFT, when multiple smaller FFTs are to be computed. Block 1230 provides for performing transform operations on the received symbols. More specifically, block 1230 provides for performing one or more FFT operations to cause the symbols to be in the frequency domain. Block 1240 provides for timing the input of each of the transform operations to enable one or more receive buffers to transmit the output of each of the two or more channels substantially when the one or more transform units require the output to perform transform operations. With reference to FIG. 11, the receiver waits after receiving symbols to compute the FFT transform to enable the receive buffer to be sized in direct proportion to the transform to be performed. Thus, the buffer can be sized to require the receiver to wait to avoid the buffer having hold data greater than the symbol size to be transformed in the FFT. The buffer can then transfer the data to an FFT. As shown in FIG. 11, the FFT can hold the data until the FFT is able to perform operations.

Unlike the transmit method, which can be applied to any OFDM modem, the receive method can be configured to be specific to VDSL or implementations that have a similar “timing advance adjustment” features combined with end-to-end transmission times, e.g., with a physical delay of the loop, that are small relative to the symbol transmission time.

While particular aspects of the subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

What is claimed is:

1. A method for preparing a symbol for use in a multiple channel communication system, the method comprising:
receiving the symbol on each of two or more channels;
performing a transform operation on each of the two or more channels; and
timing the output of each of the transform operations to enable one or more sample buffers to receive the output of each of the two or more channels substantially when the one or more sample buffers require the output of each of the transform operations.

2. The method of claim 1 wherein the symbol is a very high bit digital subscriber line (VDSL) symbol.

3. The method of claim 1 wherein the transform operation is one of an inverse fast Fourier transform (IFFT).

4. The method of claim 1 wherein the symbol is a transmit symbol, the two or more channels being provided to one or more compute processors to perform inverse fast Fourier transform (IFFT).

5. The method of claim 1 further comprising:
providing the symbol to at least a first compute buffer and at least a second compute buffer.

6. The method of claim 1 wherein the timing the output of each of the transform operations to enable the one or more sample buffers to receive the output of each of the two or more channels substantially when the one or more sample buffers require the output of each of the transform operations includes:
transferring the output of each of the two or more channels to the one or more sample buffers substantially simultaneously.

7. The method of claim 6 wherein the one or more sample buffers includes at least one sample buffer associated with each of the two or more channels.

8. The method of claim 1 wherein the performing a transform operation on each of the two or more channels includes:
performing a first inverse fast Fourier transform (IFFT) for a first channel; and
performing a second I FFT for a second channel.

9. The method of claim 8 further comprising:
receiving an output for the first channel and an output for the second channel at the one or more sample buffers, the output for the first channel and the output for the second channel organized to provide the output for the second channel and the output for the first channel to the one or more sample buffers at substantially the same time.

10. A method for receiving a symbol for use in a digital subscriber line (DSL) communication system, the method comprising:
receiving the symbol in two or more components at one or more receive buffers; and
timing the output of each of the receive buffers to enable one or more receive buffers to transmit the output to each of two or more transform components substantially when the one or more receive buffers hold a multiple of a full frequency domain symbol.

11. The method of claim 10 wherein the symbol is a very high bit digital subscriber line (VDSL) symbol.

12. The method of claim 10 wherein the two or more transform components are configured to perform a fast Fourier transform (FFT).

13. The method of claim 10 wherein the symbol is a receive symbol, the two or more channels being provided to one or more compute processors to perform a fast Fourier transform (FFT).

14. The method of claim 10 further comprising:
sizing the one or more receive buffers as a function of a transform operation to be performed by the two or more transform components.

15. The method of claim 10 wherein the timing the input of each of the receive buffers to enable one or more receive buffers to transmit the output to each of two or more transform components substantially when the one or more receive buffers hold a multiple of a full frequency domain symbol includes:
transferring the output of each of the two or more receive channels to the one or more receive sample buffers substantially simultaneously.

16. The method of claim 15 wherein the one or more sample buffers comprises at least one sample buffer associated with each of the two or more channels.

17. The method of claim 10 wherein the performing a transform operation on each of the two or more channels includes:
performing a first fast Fourier transform (FFT) for a first channel; and
performing a second FFT for a second channel.

18. A computer program product comprising:
a signal bearing medium bearing one or more instructions for preparing a symbol for use in a multiple channel communication including:
one or more instructions for receiving the symbol on each of two or more channels;
one or more instructions for performing a transform operation on each of the two or more channels;
one or more instructions for timing the output of each of the transform operations to enable one or more sample buffers to receive the output of each of the two or more channels substantially when the one or more sample buffers require the output of each of the transform operations; and
one or more instructions for providing the symbol to at least a first compute buffer and at least a second compute buffer.

19. The computer program product of claim 18 wherein the signal bearing medium comprises one or more of:
a recordable medium and/or a transmission medium.

20. A computer program product comprising:
a signal bearing medium bearing one or more instructions for preparing a symbol for use in a multiple channel communication including:
one or more instructions receiving the symbol in two or more components at one or more receive buffers
one or more instructions for timing the output of each of the receive buffers to enable one or more receive buffers to transmit the output to each of two or more transform components substantially when the one or more receive buffers hold a multiple of a full frequency domain symbol.

21. The computer program product of claim 20 wherein the signal bearing medium comprises comprises one or more of:
a recordable medium and/or a transmission medium.

22. A communication system comprising:
an analog front end (AFE) configured to receive a symbol for digital subscriber line communication;
one or more sample buffers coupled to the AFE, the one or more sample buffers configured to transmit and/or receive the symbol in two or more channels; and
two or more compute buffers coupled to the one or more sample buffers, the two or more compute buffers configured to time one or more transform operations to enable the one or more sample buffers to receive the output of each of the two or more channels substantially when the one or more sample buffers require output of each of the one or more transform operations and transfer the output of each of the two or more channels to the one or more sample buffers substantially simultaneously.

23. The communication system of claim 22 wherein the symbol is a very high bit digital subscriber line (VDSL) transmit symbol, the two or more channels being provided to the two or more compute buffers to perform an inverse fast Fourier transform (IFFT).

24. A communication system comprising
one or more receive buffers configured to receive a symbol in two or more components; and
timing means coupled to the one or more receive buffers, the timing means configured to enable the one or more receive buffers to transmit the output to each of two or more transform components substantially when the one or more receive buffers hold a multiple of a full frequency domain symbol.

25. The communication system of claim 24 wherein the symbol is a very high bit digital subscriber line (VDSL) symbol.

26. The communication system of claim 24 wherein the two or more transform components are fast Fourier transform (FFT) components.

27. The communication system of claim 24 wherein the timing means is configured to enable transferring the output of each of the two or more receive channels to the one or more receive sample buffers substantially simultaneously.
